(19) United States
(12) Patent Application Publication
(10) Pub. No.: US 2012/0194198 A1
(43) Pub. Date: Aug. 2, 2012

(54) SENSOR ARRANGEMENTS FOR MEASURING MAGNETIC SUSCEPTIBILITY

(76) Inventor: Timothy MORAN, Chicago, IL (US)

(21) Appl. No.: 13/339,931

(22) Filed: Dec. 29, 2011

Related U.S. Application Data
(60) Provisional application No. 61/427,994, filed on Dec. 29, 2010.

(51) Int. Cl. G01N 27/416; G01N 27/76

(52) U.S. Cl. 324/432; 324/201

(57) ABSTRACT

A device and method for determining the state of charge of an object, such as an electrochemical battery cell. The device includes a state of charge sensor having a primary magnet that creates a primary magnetic field, and at least one magnetic field sensing element. The sensitivity axes of the sensing elements are substantially perpendicular to the direction of polarization of the primary magnet. The primary magnet and the sensing elements are placed in the proximity of the object, and magnetic fields resulting from the magnetic susceptibility of the object are measured by the sensing elements. The sensing elements output an electrical signal from which the state of charge of the object can be determined.

### CROSS REFERENCE TO RELATED APPLICATION

The present application is related to and claims the benefit of U.S. Provisional Patent Application No. 61/427,994, filed Dec. 29, 2010, whose disclosure is hereby incorporated by reference in its entirety into the present disclosure.

### BACKGROUND OF THE INVENTION

1. Field of the Invention

The present invention relates to devices and methods for measuring the magnetic susceptibility of an object. In particular, the present invention is related to a device and method for measuring the magnetic susceptibility of a battery cell, in which the magnetic susceptibility provides an indication of the state of charge of the battery cell. The present invention exhibits an improved signal-to-noise ratio when measuring the magnetic susceptibility of the battery cell.

2. Description of the Related Art

A battery includes one or more cells, connected in a series and/or parallel arrangement, that chemically store electrical charge potential (energy) and deliver the charge at a pre-determined voltage when demanded by an external electric circuit load. Each of the battery cells contains two half-cells connected in series by an electrolyte, which may be a solid or a liquid. An electrolyte consists of anions (i.e., negatively-charged ions) and cations (i.e., positively-charged ions). One of the half-cells contains some of the electrolyte and an anode (i.e., negative electrode), toward which anions migrate. The other half-cell contains some of the electrolyte and a cathode (i.e., positive electrode) toward which cations migrate. The electrodes do not touch each other but are electrically connected by the electrolyte.

During battery operation, a redox (reduction-oxidation) reaction powers the battery. That is, the cations in the electrolyte are reduced (i.e., by the addition of electrons) at the cathode, and the anions are oxidized (i.e., by the removal of electrons) at the anode. As a battery cell discharges, ions flow from the anode, through the electrolyte, to the cathode. As the battery cell charges, the ions flow from the cathode, through the electrolyte, to the anode.

A theoretically perfect battery is capable of storing a charge that is a function of its design parameters and materials, delivering the charge to an external electrical load, and then being fully recharged to its original capacity. Thus, if one were to measure the total charge (i.e., amp-hours) entering the cells during a charge cycle, and subtract from that measurement the total charge exiting the cells during a discharge cycle, the resulting value would be an accurate indicator of the state of charge, the amount of energy stored within the cell.

However, because the charge is stored chemically, each charge-discharge cycle (as well as normal temperature cycling, vibration, shock, etc.) results in irreversible changes within the individual cells, the changes affecting cell capacity. Moreover, the rate of charge and/or discharge can also manifest in changes to cell capacity. The common result of these changes is that less energy is stored during each subsequent charge cycle. For example, as the number of charge-discharge cycles increases, the capacity of the cell decreases such that, at full voltage, the cell may only exhibit 60% capacity rather than the 95% capacity exhibited when placed into service initially. Thus, the aforementioned method of determining the state of charge by subtracting the amount of charge used from the amount of charge initially placed in the cell is flawed, because the actual charge capacity of the cell is reduced over time and usage at an unknown rate.

While the knowledge of the state of charge of a battery is needed, the need has been primarily related to convenience in the use of portable electronic devices such computers and the like. The risk resulting from uncertainty with respect to a battery's state of charge is that an inconvenience will result if the battery charge falls below useful levels.

More recently, batteries have been used in conjunction with internal combustion engines to power vehicles. These so-called hybrid vehicles are capable of operating on battery power until such time that the battery is incapable of providing the mechanical energy demanded by the operator, at which point the internal combustion engine, through an electrical generator, either supplants or augments the available battery charge.

There is increased interest in the use of vehicles that operate solely by battery power, eliminating the need for the internal combustion engine and the generator altogether. This trend is facilitated in part by advances in chemical battery technology. However, regardless of the technology used, it is still necessary to actively monitor the battery's state of charge. In purely electric vehicles, this need rises beyond convenience because, in such vehicles, there is no motive backup as is the case with hybrid vehicle configurations.

Prior attempts to compensate for the problems associated with determining state of charge have used algorithms that take into account a variety of factors including the amount of charge-discharge cycles, the rate of charge-discharge, and other factors, in an effort to weight the integrated sum of the charge entering the cell during a charge cycle, so that measured results correspond to the percentage of actual cell capacity available, as opposed to the percentage of theoretical cell capacity.

Other methods described by the prior art include measuring the voltage and/or current at one or more locations along the discharge path. Such a method is prone to numerous errors. As with the technique of measuring “charge in vs. charge out,” the method involving measuring the voltage and/or current relies on the assumption that either the properties of the cell remain constant (which is not true in practice), or that the changes over usage and time reliably follow an algorithm correction factor (which is generally the case, but only within a statistical band, and with potential “outliers”). Because a battery is comprised of numerous cells connected in series and/or parallel, an individual cell that is behaving as a statistical outlier in relation to the other cells, can significantly degrade the function of the battery as a whole.

In U.S. Pat. No. 5,537,042, a single coil located in proximity of a cell electrode is excited with an alternating electric current. The state of charge of the cell determines the complex impedance of the coil and its near environment. There are a number of limitations to this approach. For example, the measurement circuit output is not solely reflective of the complex impedance of the coil/electrode circuit itself, but of the entire circuit, including all of the electrical interconnects and wire runs between the coil and measuring circuit. Any resistive or reactive influence to the circuit will add error to the measurement. Moreover, the '042 patent teaches embodiments in which the complex impedance measurement of interest relates to the “plates” of the battery cells. Accordingly, the disclosed embodiments of such a device will employ relatively large coils in order to maximize their interaction with the cell plates. In addition to the obvious packaging issues, larger coils require substantially more power for excitation at the requisite levels, leading to less efficiency and increased likelihood of propagating electromagnetic fields that may interact with other measurement coils or nearby electronics.

International patent application PCT/US2010/023181, which is hereby incorporated by reference in its entirety, discloses a device and method for measuring the magnetic susceptibility of an object, in particular, the electrolyte or electrode within a battery cell, by generating a magnetic field that permeates the object. The object (i.e., the battery cell) exhibits a magnetic susceptibility, which is dependent upon the state of charge of the object. The strength and flux density of the generated, or primary, magnetic field must be great enough to permeate the object across the distance from the primary magnetic field source to the object, and to interact with the object such that the variation in properties of the primary magnetic field caused by the magnetic susceptibility of the object, resulting in a secondary magnetic field, can be sensed by a magnetic field sensing device that may be located proximate to the primary magnetic field generator. Packaging, location, and other design limitations of the system may result in minimal difference in field strength between the primary and secondary magnetic fields. In practice, the difference between the primary and secondary fields may so small, that measurement of that difference lacks usefulness due to limitations of the magnetic field sensor resolution and/or accuracy. The '181 application describes the use of flux directors made from highly magnetic permeable materials which enable (a) use of a less powerful primary magnetic field source, and (b) the ability to “steer” the primary magnetic flux direction such that the secondary magnetic field sensor is less likely to sense the primary field (i.e., is proportionally more effective at sensing the secondary vs. the primary magnetic field). However, design limitations may place restrictions on the size, location, and orientation of the flux directors, and the highly permeable materials used in their construction are expensive and subject to wide variations and cost due to limited supply. Moreover, the permeability of these materials varies as a function of, among other factors, temperature, which requires that an additional compensation factor be applied to the sensed secondary magnetic field for obtaining an accurate state of charge measurement. Adding further uncertainty to the state of charge measurement is the potential variation in the primary magnetic field strength, which, even if the primary field is modulated so as to distinguish from ambient magnetic fields, will nonetheless corrupt the output of the secondary magnetic field sensor which is tuned to the same modulation parameters.

Other methods of evaluating the state of charge within a battery cell require that a sensor be immersed within the cell, or that a sample of the cell electrolyte be removed, in order to measure properties such as density (specific gravity) or optical characteristics. However, those methods are costly and may be unsuitable for practical applications. Furthermore, those methods may not work with all types of electrolytes, especially those that are less mobile, which is the case for lithium-ion batteries.

Accordingly, there is a need for a device and method for measuring the state of charge of an electrical battery cell that overcomes the limitations of the prior art.

### SUMMARY OF THE INVENTION

It is a principle object of the present invention to provide a device for determining, monitoring, and providing an indication of the state of electrical charge of an object.

It is another object of the present invention to provide a device and method for determining, monitoring, and providing an indication of the magnetization, the magnetic moment, and the magnetic permeability of an object.

It is yet another object of the present invention to provide a component of an automotive device, consumer electronic device, or other type of device having an electrical battery, and in particular to provide an electrical battery, one or more electrical battery cells within the battery, and one or more sensors for measuring the state of charge of the battery cells, wherein the component is assembled to measure the magnetic susceptibility of the electrolyte or electrodes within the battery cells.

It is yet another object of the present invention to provide a method for monitoring the state of charge of the battery and the battery cells using sensors, thereby determining the state of charge at any given time or over a given or a predetermined time period.

It is yet another object of the present invention to use one or more permanent magnets to direct a magnetic field through the battery cell enclosure and electrolyte and/or electrodes, and to use one or more fluxgate magnetometers to measure the degree to which the magnetic field is influenced as a result of the magnetic susceptibility of the electrolyte and/or electrodes, in order to obtain useful information about the battery cell state of charge.

It is yet another object of the present invention to provide a sensor for monitoring the state of charge of a battery cell, the sensor having at least one permanent magnet mounted on a substrate, a printed circuit board (which may also form the aforementioned substrate), at least one wire leading to a sensor circuit, a first of at least two sense coils, wherein each of the at least two sense coils preferably has an amorphous core, and wherein the permanent magnet is positioned such that its principal flux path through the battery cell is in a direction substantially normal to the sensitivity axis of the at least two sense coils.

It is yet another object of the present invention to provide a sensor that can be easily mounted to the battery cell without adding substantial weight or requiring substantial change to the size of the battery cell.

It is yet another object of the present invention to provide a sensor housing attached to the mounting device for housing the sensor components to protect them from the surrounding environment.

It is yet another object of the present invention to provide a sensing circuit that receives a signal over the at least one wire, and wherein the signal provides information about a magnetic susceptibility of the battery cell.

It is yet another object of the present invention to provide a sensor for use with a battery cell of a battery, where the battery cell is an LFP battery cell, and the battery is used in a motor vehicle.

It is yet another object of the invention to provide a solenoid coil around each of the at least one sense coils that generates an offset magnetic field that cancels the acquiescent fields of the at least one permanent magnets.

It is yet another object of the invention to provide a state of charge sensor that does not require the use of a flux director.

It is yet another object of the invention to provide a state of charge sensor that does not require the modulation of a primary magnetic field or magnetic field sensing elements.

Those and other objects and advantages of the present invention are accomplished, as fully described herein, by a method comprising the steps of: using at least one permanent magnet to generating a magnetic field; directing the magnetic field through a battery cell electrolyte and/or electrode; and using one or more fluxgate coils to measuring the resulting magnetic field strength after the magnetic field has been linked through the electrolyte and or electrodes. Fluxgate coils are used in the preferred embodiment due to their ability to accurately measure very low levels of magnetic field strength, and the at least one permanent magnet is positioned such that its principal flux path through the battery cell is in a direction substantially normal to the sensitivity axis of the at least two sense coils.

The objects and advantages of the present invention are also accomplished, as fully described herein, by an apparatus for monitoring the state of charge of a battery cell comprising: a battery state of charge sensor adapted to being attached proximate to a battery cell, the sensor comprising: at least one permanent magnet for creating a magnetic field; and at least one fluxgate coil for sensing a change in the magnetic field and outputting a signal based upon the sensed change, the signal being indicative of the state of charge of the battery cell. The apparatus may further comprise a battery cell, the battery cell comprising a battery cell electrode and an electrolyte in contact with the battery cell electrode.

### DESCRIPTION OF THE DRAWINGS

Those and other objects, advantages, and features of the invention, as well as the invention itself, will become more readily apparent from the following detailed description when read together with the following drawings, in which:

FIG. 1 is a block diagram illustrating an object and a state of charge sensor having a single permanent magnet and two fluxgate sensor coils, in accordance with an embodiment of the present invention;

FIG. 1A is a block diagram illustrating the magnetic flux path from a pole of a permanent magnet, through an object being measured, and returning to the opposite pole of the magnet, in accordance with an embodiment of the present invention;

FIG. 2 is a block diagram illustrating an object and a state of charge sensor having three permanent magnets and two fluxgate sensor coils, in accordance with another embodiment of the present invention;

FIG. 3 is a block diagram illustrating an object and a state of charge sensor having a single permanent magnet and two fluxgate sensor coils, each fluxgate sensor coil including an environmental field cancellation solenoid coil, in accordance with another embodiment of the present invention;

FIG. 4 is a block diagram illustrating a state of charge sensor having fluxgate sensor coils with exchange biased soft material, in accordance with another embodiment of the invention;

FIG. 5 is a block diagram illustrating a state of charge sensor having magnetoresistive sensing elements, in accordance with another embodiment of the invention;

### DETAILED DESCRIPTION OF THE INVENTION

Several preferred embodiments of the invention are described for illustrative purposes, it being understood that the invention may be embodied in other forms not specifically shown in the drawings. The figures are described with respect to the system architecture and methods for using the system to achieve one or more of the objects of the invention and/or receive the benefits derived from the advantages of the invention as set forth above.

The present invention is directed to a sensor for measuring the magnetic susceptibility of an object by generating a magnetic field that permeates the object and by sensing the resultant changes in that magnetic field. The “object” of which the magnetic susceptibility is to be measured may be a volume with constant or variable magnetic susceptibility, as may be related to some other physical quantity or condition. Examples of the physical condition include but are not limited to the material temperature, the concentration of ions in the material, or the structure of the material.

In general, the device and method, as more fully described herein in terms of their application to a battery cell, involve positioning an excitation magnet adjacent to the object to be measured, and positioning a set of magneto-inductive magnetic field sensing elements (i.e., magnetic field sensors) adjacent to the object so that the magnetic flux lines from the permanent magnet permeate the sensing elements as well as the object. The path of the magnetic flux lines extends through both the object and the sensing elements. The device, therefore, includes an excitation magnet, and one or more sensing elements. The amount of magnetization of the object depends upon both the applied magnetic field and the magnetic properties of the object. The magnetization of the object then creates its own magnetic field components, external to the object, that modify the magnetic field around the object. The sensing elements measure the change in the magnetic field outside the object caused by the magnetic properties of the object (i.e., the object's magnetic susceptibility) or the magnetization of the object.

In an alternate embodiment of the invention, the device may include a DC electromagnet, or an AC modulated electromagnet. Alternatively, the device may function without including any magnetic field source at all, but may instead rely on some other existing magnetic field source in the vicinity of the object being measured. The device may also function by utilizing only the intrinsic magnetic field of the object itself. The magnet and the sensing elements may be combined into one single part. The sensing elements need not be “magneto-inductive.” Rather, they may operate by a variety of methods.

In the figures, a device and method for determining the state of charge of an object, particularly a battery, and more particularly a battery cell, are shown and suggested to illustrate one application of the present invention. The state of charge of the battery is determined by measuring the magnetic susceptibility of the electrolyte and electrodes. The illustrated device includes one or more permanent magnets, one or more fluxgate magnetometer coils (i.e., sensing elements), and associated electronic circuitry. During operation of the invention, the sensing elements output an electrical signal that is linearly related to a sensed magnetic field, which is linearly related to the magnetic susceptibility of the object, which is linearly related to the state of charge of the object. Accordingly, there is a linear relationship between the output signal of the sensing elements and the state of charge of the object. Because of this linear relationship, the state of charge can be calculated as a linear function of the output signal. Preferably, each sensing element exhibits a high value of gain without causing saturation of the output signal.

The following equations provide an example of how the state of charge of an object may be determined based on the output signal provided by the sensing elements of the present invention:

V=V_{(offset)}+a·H_{(sensing element)}

H_{(sensing element)}=b·χ

χ=c+d·SOC

where V is the output of the sensing elements, V_{(offset)} is an offset voltage, H_{(sensing element)} is the magnetic field strength measured by the sensing element, a is a sensor scale factor, b is a linkage between magnetic susceptibility and magnetic field strength, χ is the magnetic susceptibility of the object, c is the magnetic susceptibility of the object in a low charge state, d is a conversion factor for magnetic susceptibility and state of charge, and SOC is a number between 0 and 1 representing the state of charge of the object.

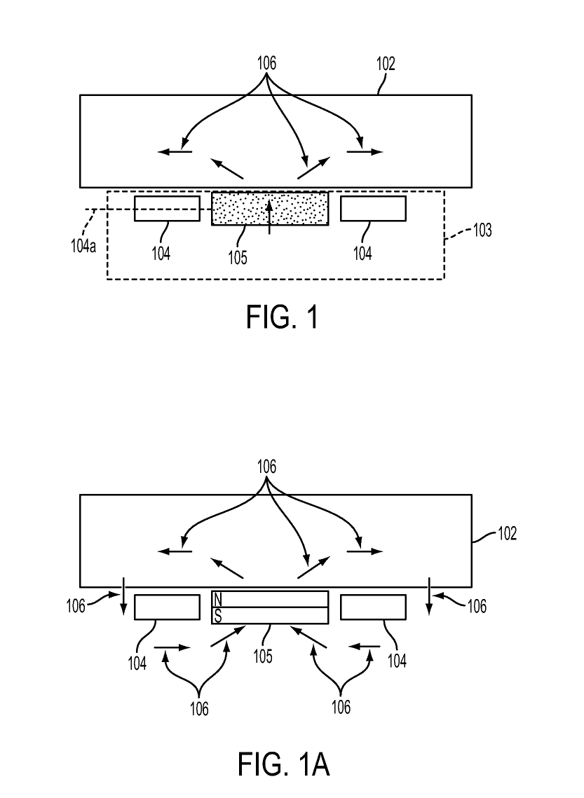

The preferred arrangement of the components of the present invention involves placing a state of charge sensor 103 having at least one permanent magnet 105 in close proximity to an object 102, such as a battery cell, as shown in FIGS. 1-3. Preferably, the state of charge sensor 103, particularly the magnet 105 and the sensing coils 104, is positioned within 10 mm of the object 102, and more preferably within approximately 3 mm of the object 102. The distance between the state of charge sensor 103 and the object 102 is selected to ensure that the magnetic field created by the magnet 105 permeates the object 102, and that the output signal from the sensor coils 104 is primarily attributable to the magnetic susceptibility of the object 102. The state of charge sensor 103 may be attached to the object 102 by any suitable attachment means.

Turning first to FIG. 1, shown therein is a block diagram having an object 102 to be measured (a single battery cell in the preferred embodiment) by a state of charge sensor 103, according to the present invention. The object 102 is shown, for illustrative purposes, as having a rectangular shape, although other shapes and sizes are also contemplated. The object 102 may be made of any known battery cell materials suitable for the applications described herein. For example, the object 102 may be a lithium-iron-phosphate (LiFePO₄, or LFP) battery cell. The state of charge sensor 103 may be positioned proximate to, or directly attached to, any suitable portion of the object 102, though specific positions will be readily apparent to the skilled artisan taking into account the configuration, size, and shape of the object 102, and in instances in which the object is a battery, other battery cells, the assembly of battery cells and electrolyte, battery housing, and other factors.

As shown in FIGS. 1 and 1A, the primary magnet 105 is positioned proximate to the object 102 in such a manner that the north pole of the primary magnet 105 faces directly toward the object 102 and the south pole of the primary magnet 105 is on the side of the primary magnet 105 opposite the object 102. The polarity of the primary magnet 105 could be reversed, and the system would operate in the same fashion (although the polarities of the resulting induced magnetic fields would also be opposite). As shown by the field direction arrows 106, the path of magnetic flux enters the object 102 in a direction normal to the sensor coil axis 104a. The magnetic flux path continues through the object 102, and exits the object 102 toward the pole of the primary magnet 105 on the side opposite the object 102.

In the preferred embodiment, sensor coils 104 are fluxgate magnetometer coils having an amorphous core around which the coils are wound. As is known in the art, this type sensor coil 104 has a sensitivity axis that is coaxial to the core of the sensor coil 104. As a result, the sensor coil 104 will not be responsive to magnetic flux lines oriented in a direction normal to the axis 104a of the sensor coil 104.

Referring to FIG. 1A, the arrows 106 indicating magnetic field directions approximate the flux path from one pole of the primary magnet 105 to the other. Because of the position of the primary magnet 105 relative to sensor coils 104, the direction of magnetic flux that intersects the sensor coils 104 is substantially normal to the axes 104a of the sensor coils 104, which is the intersection path in which the sensor coils 104 exhibit the least amount of sensitivity.

The magnetic susceptibility of the object 102 results in secondary magnetic fields that are normal to the polarity of the primary magnet 105, and these fields will be proportional to the magnetic susceptibility of object 102. In other words, in this preferred embodiment of the present invention, the magnetic fields arising from the magnetic susceptibility of the object 102 will have a flux direction which is substantially aligned with the sensitivity axes 104a of the sensor coils 104. Therefore, the sensor coils 104 are predominantly affected by the magnetic fields arising due to the magnetic susceptibility of the object 102, and to a much lesser extent, by the fields arising directly from the primary magnet 105. Considering that, from the perspective of measuring a property of the object 102, the fields arising directly from the primary magnet 105 are common mode noise, then the arrangement described hereinabove effectively increases the signal-to-noise ratio of the measurement because it maximizes sensitivity to magnetic flux projected from the object 102 and minimizes sensitivity to magnetic flux projected from the primary magnet 105.

Another source of error in measuring magnetic susceptibility arises from other sources of magnetism in the environment, whether they be from the Earth's magnetic field or from other sources, such as electric motors and the like. These external sources of magnetism are generally considered “far field” sources, meaning that the field gradient between the multiple sensor coils 104 is relatively small. Accordingly, in an exemplary case involving two sensor coils 104, the strength of the noise field detected by each of the two sensor coils 104 is substantially the same. This source of error can be addressed by connecting the two sensor coils 104 in a subtractive series manner. In other words, the sensor coils 104 are connected in series but with opposite physical polarities, such that the noise field sensed by one of the sensor coils 104 is cancelled by the subtraction of the equal but oppositely sensed noise field through the other sensor coil 104.

There may be other sources of noise that can adversely affect the accuracy of the magnetic susceptibility measurement of the object 102. If, for example, an electric motor or other magnetic field source is located near enough to the state of charge sensor 103, the externally originated magnetic field is considered to be a “near field,” which will have significant and measurable field strength gradient between the sensor coils 104. Another potential source of undesirable near field noise can be the primary magnet 105. If the positioning between the primary magnet 105 and the sensor coils 104 is not sufficiently precise, one of the two or more sensor coils 104 may sense a greater axial component of the primary magnetic field than will the other sensor coil(s) 104, resulting in an offset error in the magnetic susceptibility measurement. Also, packaging limitation may be such that it is not practicable to locate sensor coils 104 at an ideal distance ideal from the primary magnet 105 to ensure that the primary magnetic field component along the sensitivity axes 104a of the sensor coils 104 is zero.

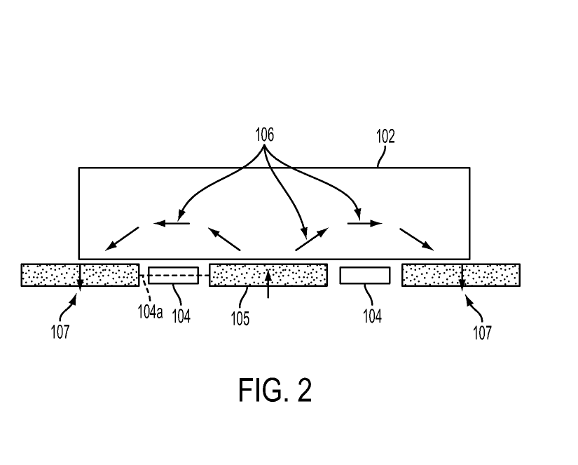

Another exemplary embodiment of the present invention, shown in FIG. 2, includes two secondary magnets 107, which are located outboard of the sensor coils 104 (i.e., on the sides of the sensor coils 104 opposite the primary magnet 105). These secondary magnets 107 are both magnetically oriented in a direction opposite to the magnetic orientation of the primary magnet 105 (i.e., with their north poles facing the opposite direction as the north pole of the primary magnet 105). The use of secondary magnets 107 increases the strength of the primary magnetic field projected into object 102, and decreases the level of the undesirable off-axis field sensed by the sensor coils 104 (off-axis referring to the magnetic field intended to permeate into that object 102, but that is aligned with the axes 104a of the sensor coils 104).

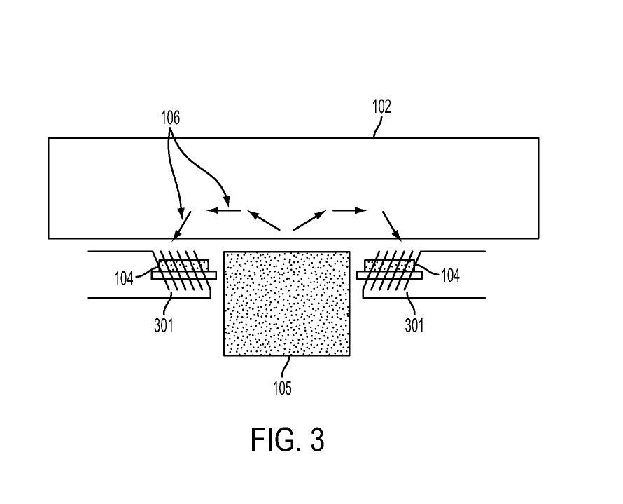

FIG. 3 illustrates an exemplary embodiment of the present invention that includes cancellation coils 301 that can be positioned in close proximity to the sensor coils 104 or, as shown in FIG. 3, surrounding the sensor coils. The cancellation coils 301 may be solenoid electromagnets. The cancellation coils 301 are energized with a controlled level of current in such a manner as to generate a magnetic field having a strength equal and opposite to the axial vector component of the interfering magnetic field (i.e., noise field), thereby effectively canceling the effects of the interference. An additional feature of this embodiment is that, if the magnetic field levels of interest (e.g., those used for measuring magnetic susceptibility) are either low enough or high enough to cause the sensor coils 104 to operate in a non-linear region of their sensitivity range. The cancellation coils 301 may be used to either raise or lower the median magnetic field strength, thereby allowing the sensor coils 104 to operate in their linear regions. Depending on the desired function of the cancellation coils 301, they may be energized separately, or they may be connected in series to a common current source.

Generally, fluxgate coils are designed to operate in the presence of a relatively small magnetic field having a strength of less than 10 Gauss, and preferably less than 1 Gauss. In such instances, the fluxgate coils will generally be insensitive to magnetic fields that are perpendicular to the sensitive axes of the fluxgate coils. However, fluxgate coils may exhibit an undesirable sensitivity to relatively large magnetic fields (i.e., greater than 10 Gauss), even those perpendicular to the sensitive axes of the fluxgate coils. Therefore, the presence of a relatively large magnetic field may disrupt the operation of the fluxgate coil. A permanent magnet may create a relatively large magnetic field, thereby adversely affecting the operation of nearby fluxgate coils. Preferably, the permanent magnet 105 of the present invention creates a relatively large magnetic field having a strength of greater than 100 Gauss, and more preferably, in the approximate range of 100 to 200 Gauss. A relatively large magnetic field is preferred in order to ensure that any significant measurable changes in the magnetic field are attributable to the magnetic susceptibility of the object to be measured. To provide more robust sensing elements that are generally insensitive to relatively large magnetic fields created by the permanent magnet, the present invention may be configured to take advantage of the principle of shape anisotropy.

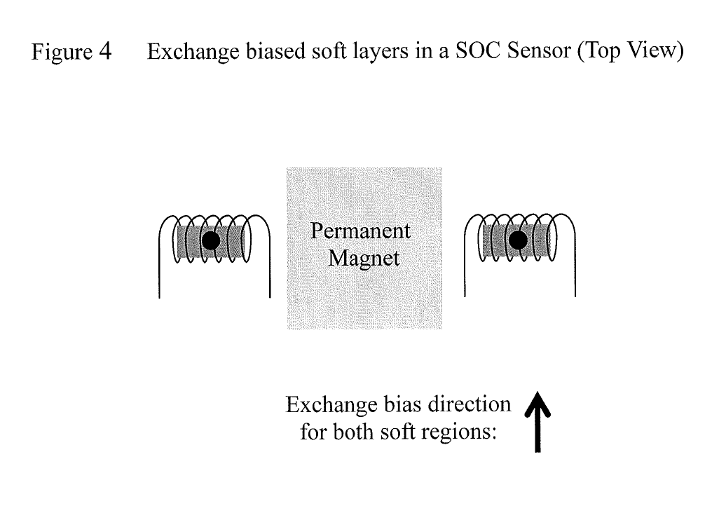

FIG. 4 illustrates an exemplary embodiment of a state of charge sensor 403 in which the sensor coils 404 are fluxgate coils. The core structure of each sensor coil 404 includes core material 412 having a first layer of soft material, which is preferably permalloy, such as NiFe. The core material 412 also has and a second layer of antiferromagnetic material, such as NiMn, in contact with the first layer. The core material 412 may be disposed on a substrate 410 which may be formed of silicon, for example. The shape anisotropy of soft material layer causes the sensor coil 404 to be very insensitive to the large magnetic fields created by the nearby permanent magnet 405. The exchange bias produced by the antiferromagnetic layer enables smooth transitions of the magnetization switching in the sensor coil 404, and low noise in the output signal of the sensor coil 404. In FIG. 4, the sensor coils 404 are shown having sensitivity axes 404a that are perpendicular to the exchange bias direction indicated by an arrow 407. Both the sensitivity axes 404a and the exchange bias direction are perpendicular to the polarization of the permanent magnet, which is directed up from the page, as indicated by dots 408. In the embodiment shown in FIG. 4, an object (not shown) to be measured is preferably positioned just above the page, such that the magnetic field created by the permanent magnet 405 permeates the object.

The description of the invention and several of its embodiments thus far has focused on the use of fluxgate coils for the sensor coils 104 of the state of charge sensor 103. It will be appreciated by those having skill in the art that the present invention is equally applicable to state of charge sensing systems that use other types of sensing elements that are sensitive to magnetic fields along a particular axis, such as magnetoresistive, giant magnetoresistive, Hall cell, and any sensor that does not simultaneously respond to multiple vector components of a magnetic field.

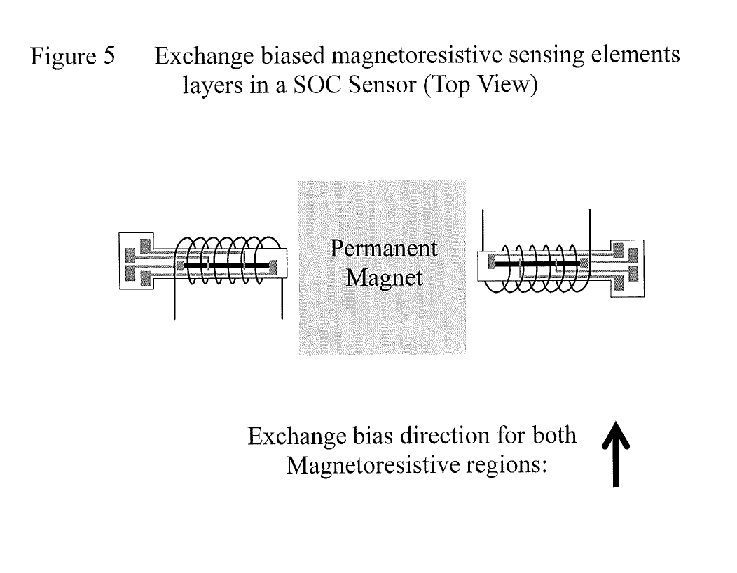

FIG. 5 shows yet another exemplary embodiment of the state of charge sensor 503 in which the sensing elements 504 are magnetoresistive elements, which can exhibit anisotropic magnetoresistance, spin valve magnetoresistance, or tunneling magnetoresistance. To enable high sensitivity and low noise, the sensing elements 504 are excited with an AC magnetic field as described, for example in U.S. Pat. Nos. 5,747,997 and 6,166,539. Similar to the sensor coils 404 shown in FIG. 4, the sensing elements 504 shown in FIG. 5 include core material 512 having a soft material layer and an antiferromagnetic layer. The shape anisotropy of the soft material layer causes each sensing element 504 to be very insensitive to the large magnetic fields created by the nearby permanent magnet 505, and the exchange bias produced by the antiferromagnetic layer enables smooth transitions of the magnetization switching in the sensing element 504, and low noise in the output signal of the sensing element 504. In FIG. 5, the sensing elements 504 are shown having sensitivity axes 404a that are perpendicular to the exchange bias direction indicated by an arrow 507. Both the sensitivity axes 504a and the exchange bias direction are perpendicular to the polarization of the permanent magnet, which is directed up from the page, as indicated by dots 508. In the embodiment shown in FIG. 5, an object (not shown) to be measured is preferably positioned just above the page, such that the magnetic field created by the permanent magnet 505 permeates the object.

The type of magnet used as primary and secondary magnets 105, 107 is also not limited to a specific type of magnet, although it is preferred that the magnetic material be stable over time and exhibit minimal thermal coefficient of magnetic strength and flux density. Preferably, the materials used to form the primary and secondary magnets 105, 107 include neodymium iron boride and samarium cobalt, although others could be used with varying degrees of accuracy and possibly in conjunction with temperature sensors located proximate to the primary and secondary magnets 105, 107 that could be used to provide an offset correction value. Preferably, a permanent magnet is used. However, in an alternative embodiment, a DC electromagnet may be used instead of a permanent magnet. In yet an alternative embodiment, an AC modulated electromagnet could be used. When an AC modulated electromagnet is used as the primary magnet 105, the magnetic field strength that must be produced inside the object to accurately measure its magnetic susceptibility may be less than the magnetic field strength required when a permanent magnet is used. When an AC modulated electromagnet is used, the output of the sensing elements 104 is tuned to the same modulation parameters as the AC modulated electromagnet.

The present invention may include additional features such as a mounting device for mounting the state of charge sensor to a battery cell, or a housing for housing the components of the present invention to protect them from the surrounding environment.

In one application of the present invention, the distance between the state of charge sensor 103 and the object 102 may be varied, and the output signal of the sensor coils 104 may be monitored at the various distances. The value of the output signal measured at a far distance may then be subtracted from the value of the output signal measured at a near distance to cancel the effects of noise on the sensor coils 104. A far distance is one (approximately 10 mm or greater in the preferred embodiment) at which the output signal is affected only by noise, and not by the magnetic susceptibility of the object 102. A near distance is one (approximately 3 mm or less in the preferred embodiment) at which the output signal is affected primarily by the magnetic susceptibility of the object 102. The state of charge sensor 103 may therefore include a means for varying the distance between the state of charge sensor 103 and the object 102, such as a sled that slidably varies the distance between the state of charge sensor 103 and the object 103.

Other useful applications of the present invention contemplated include those in the following fields of endeavor and industry: battery cell manufacturers (quality control, etc.), battery management systems groups, automobile companies (hybrid-electric vehicles, electric vehicles, etc.), battery users, portable battery-operated electronic device manufacturers, chemists, physicists, biologists, material scientists, pharmaceutical quality control, environmental scientists, soils scientists, Federal Department of Agriculture, manufacturers of a variety of products (defect detection, quality control), medical device manufacturers, Magnetic Resonance Imaging (MRI) manufacturers, and state-of-the art lock manufacturers (safes).

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by any appended claims and the applicable rules of law.

I claim:

1. A method for determining the state of charge of an electrochemical storage cell comprising the steps of:
providing a first magnet, wherein the first magnet outputs a primary magnetic field attributable to the magnetization of the first magnet;
providing at least one magnetic field sensing element having a sensitivity axis, wherein the sensitivity axis is substantially perpendicular to the direction of the primary magnetic field at the location of the at least one sensing element;
positioning the first magnet and the at least one sensing element in proximity to the electrochemical storage cell such that the primary magnetic field permeates the electrochemical storage cell;
measuring an output signal output by the at least one sensing element; and
determining the state of charge of the electrochemical storage cell based on the measured output signal.

2. The method of claim 1, wherein the sensitivity axis is substantially perpendicular to the direction of polarity of the first magnet.

3. The method of claim 1, wherein the output signal is substantially insensitive to the primary magnetic field of the first magnet.

4. The method of claim 1, wherein the step of providing at least one magnetic field sensing element comprises providing a plurality of sensing elements, and wherein the sensing elements are configured to collectively output the output signal.

5. The method of claim 4, wherein the plurality of sensing elements are configured to cancel the effects of a common mode ambient field on the output signal.

6. The method of claim 1 further comprising the steps of:
providing at least one cancellation coil,
wherein the at least one cancellation coil corresponds to the at least one sensing element, and
wherein the at least one cancellation coil is configured to control the strength of the magnetic field sensed by the corresponding sensing element.

7. The magnetic susceptibility sensor of claim 6, wherein the at least one sensing element is disposed inside the corresponding cancellation coil.

8. The method of claim 1, wherein the at least one sensing element further comprises a core material having:
a first layer of magnetically soft material; and
a second layer of antiferromagnetic material.

9. The method of claim 1, wherein the at least one sensing element is a fluxgate coil.

10. The method of claim 1, wherein the at least one sensing element is a magnetoresistive sensing element.

11. A magnetic susceptibility sensor comprising:
a first magnet for outputting a primary magnetic field attributable to the magnetization of the first magnet, wherein the first magnet is configured such that, when the first magnet is proximate an object having a magnetic susceptibility, the primary magnetic field permeates the object and a secondary magnetic field results due to the magnetic susceptibility of the object;
at least one magnetic field sensing element for outputting a signal corresponding to a sensed magnetic field, each sensing element having a corresponding sensitivity axis; and
a signal processing device for determining the magnetic susceptibility of the object based on the signal;
wherein the sensitivity axis is substantially perpendicular to the direction of the primary magnetic field at the location of the corresponding at least one sensing element.

12. The magnetic susceptibility sensor of claim 11, wherein the sensitivity axis is substantially perpendicular to the direction of polarity of the first magnet.

13. The magnetic susceptibility sensor of claim 11, wherein the outputted signal is substantially insensitive to the primary magnetic field.

14. The magnetic susceptibility sensor of claim 11, further comprising a plurality of sensing elements, wherein the plurality of sensing elements are each configured to collectively output the output signal, and wherein the sensing elements are configured to cancel the effects of a common mode ambient field on the output signal.

15. The magnetic susceptibility sensor of claim 11, further comprising at least one cancellation coil,
wherein the at least one cancellation coil corresponds to the at least one sensing element, and
wherein the at least one cancellation coil is configured to cancel the primary magnetic field at the location of the corresponding sensing element.

16. The magnetic susceptibility sensor of claim 15, wherein the at least one sensing element is disposed inside the corresponding cancellation coil.

17. The magnetic susceptibility sensor of claim 11, further comprising at least one cancellation coil,
wherein the at least one cancellation coil corresponds to the at least one sensing element, and
wherein the at least one cancellation coil is configured to increase or decrease the strength of a magnetic field sensed by the corresponding sensing element, such that the corresponding sensing element operates in a linear range.

18. The magnetic susceptibility sensor of claim 17, wherein each sensing element is disposed inside the corresponding cancellation coil.

19. The magnetic susceptibility sensor of claim 11, further comprising a second magnet disposed proximate to the at least one sensing element, wherein the second magnet is configured to cancel the primary magnetic field at the location of the at least one sensing element.

20. The magnetic susceptibility sensor of claim 11, wherein the at least one sensing element further comprises core material having:
a first layer of magnetically soft material; and
a second layer of antiferromagnetic material.

21. The magnetic susceptibility sensor of claim 11, wherein the at least one sensing element is a fluxgate coil.

22. The magnetic susceptibility sensor of claim 11, wherein the at least one sensing element is a magnetoresistive sensing element.

23. A magnetic susceptibility sensor comprising:
a first magnet for outputting a primary magnetic field attributable to the magnetization of the first magnet, wherein the first magnet is configured such that, when the first magnet is proximate an object having a magnetic susceptibility, the primary magnetic field permeates the object and a secondary magnetic field results due to the magnetic susceptibility of the object;
a first magnetic field sensing element disposed adjacent to the first magnet, the first sensing element having a sensitivity axis substantially perpendicular to the direction of the primary magnetic field at the location of the first sensing element;
a second magnetic field sensing element disposed adjacent to the first magnet on a side of the first magnet opposite the first sensing device, the second sensing element having a sensitivity axis substantially perpendicular to the direction of the primary magnetic field at the location of the second sensing element; and
a signal processing device,
wherein the first and second sensing elements are configured to collectively output a signal corresponding to a sensed magnetic field, and
wherein the signal processing device is configured to determine the magnetic susceptibility of the object based on the signal.

24. The magnetic susceptibility sensor of claim 23 further comprising:
a second magnet disposed adjacent to the first sensing element on a side of the first sensing element opposite the first magnet; and
a third magnet disposed adjacent to the second sensing element on a side of the second sensing element opposite the first magnet,
wherein the direction of polarity of the second magnet is opposite the direction of polarity of the first magnet,
wherein the direction of polarity of the third magnet is opposite the direction of polarity of the first magnet,
wherein the direction of a magnetic field outputted by the second magnet is substantially perpendicular to the first and second sensing elements at the locations of the first and second sensing elements, and
wherein the direction of a magnetic field outputted by the third magnet is substantially perpendicular to the first and second sensing elements at the locations of the first and second sensing elements.

25. The magnetic susceptibility sensor of claim 23, wherein the first and second sensing elements are connected in series such that the output signal of one of the first and second sensing elements is subtracted from the output of the other sensing element.

26. The magnetic susceptibility sensor of claim 23 further comprising:
a first cancellation coil configured to control the strength of the magnetic field sensed by the first sensing element; and
a second cancellation coil configured to control the strength of magnetic field sensed by the second sensing element.

27. The magnetic susceptibility sensor of claim 26, wherein the first sensing element is disposed inside the first cancellation coil, and wherein the second sensing element is disposed inside the second cancellation coil.

28. The magnetic susceptibility sensor of claim 23,
wherein the first sensing element further comprises core material having:
a first layer of magnetically soft material; and
a second layer of antiferromagnetic material, and
wherein the second sensing element further comprises core material having:
a first layer of magnetically soft material; and
a second layer of antiferromagnetic material.

29. The magnetic susceptibility sensor of claim 23, wherein the first and second sensing element are fluxgate coils.

30. The magnetic susceptibility sensor of claim 23, wherein the first and second sensing element are magnetoresistive sensing elements.
